(19) United States
(12) Patent Application Publication
(10) Pub. No.: US 2024/0331273 A1
(43) Pub. Date: Oct. 3, 2024

(54) VIRTUAL VIDEO COMPOSITION

(71) Applicants: William L. O'CONNOR, Falls Church, VA (US); John D. O'CONNOR, Falls Church, VA (US)

(72) Inventors: William L. O'CONNOR, Falls Church, VA (US); John D. O'CONNOR, Falls Church, VA (US)

(21) Appl. No.: 18/619,374

(22) Filed: Mar. 28, 2024

Related U.S. Application Data
(60) Provisional application No. 63/492,602, filed on Mar. 28, 2023.

(51) Int. Cl. G06T 15/20; G06T 5/00; H04N 13/243; H04N 13/296

(52) U.S. Cl. CPC G06T 15/20; G06T 5/00; H04N 13/243; H04N 13/296; G06T 2207/10016; G06T 2207/20204

(57) ABSTRACT

Provided is a process relating to virtual video composition through a unique combination of manufacturing techniques that improve fidelity over prior methods or attempts at producing high-quality cinematic video.

### CROSS-REFERENCE TO RELATED APPLICATIONS

This application claim priority to and the benefit of U.S. Provisional Application Ser. No. 63/492,602, filed Mar. 28, 2023.

### BACKGROUND

A process which describes virtual video composition through a unique combination of manufacturing techniques that improve fidelity over prior methods or attempts at producing high-quality cinematic video.

Utilizing cutting-edge technology and techniques, high-quality cinematic video can be created by combining volumetric signature captures with a high-definition physically based rendered virtual world. This involves heavy usage of photogrammetric 3D models, accurate and believable horizons, scene-appropriate shaders, physically based lighting, and real-world camera and lens emulation. Additionally, frame-by-frame real-world filmstock grain emulation is applied to enhance the visual quality of the video. Once these elements have been combined, the generated images are compiled into video format to produce the final product.

### SUMMARY

The method comprises steps involving a synchronized multi-camera capture system setup, detailed refinement of a volumetric video signature, intricate photogrammetric modeling complemented by precise bone-mapping, real-time processing for the removal of visual artifacts, synchronization of motion capture data with volumetric video, application of cinematic camera emulation within an interactive virtual setting, and the rendering of a cinematic video infused with film grain emulation to achieve an authentic cinematic quality.

In one embodiment, the method comprises first creating a virtual setting and then creating a virtual camera. A volumetric video signature is then captured. The volumetric video signature and the virtual camera are then placed in the virtual setting. Once so placed, a cinematic video based on the placed captured volumetric video signature and the virtual camera in the virtual setting is rendered.

### BRIEF DESCRIPTION OF THE DRAWING

FIG. 1 depicts a flowchart of one embodiment of the present invention.

FIG. 2 depicts a flowchart of another embodiment of the present invention.

FIG. 3 depicts a volumetric signature capture before rendering.

FIG. 4 depicts a volumetric signature capture after rendering.

### DETAILED DESCRIPTION

Initially, a comprehensive photogrammetric capture of the performers is conducted to model them in three dimensions with precise bone mapping, which facilitates the subsequent application and alignment of motion capture data. An advanced camera system, including a Black Magic Pocket Cinema 6k camera and a Microsoft Azure Kinect, is harmoniously synchronized to capture comprehensive data. A separate Kinect V2 camera is dedicated to motion capture.

Data from the Black Magic camera is securely recorded to a solid-state drive while being processed in real-time by an Ultimatte system to produce a clean cutout of the performers. The refinement mask created through this process ensures the actors are distinctly separated from the background.

The captured footage undergoes a refinement stage with DepthKit and the Refinement Mask to generate a volumetric capture free of artifacts. This volumetric capture is then integrated with the photogrammetric model within the Unity Engine. The physical attributes of the model are retained, including mesh colliders, bones, and animations, while its visual rendering is disabled in favor of the volumetric capture.

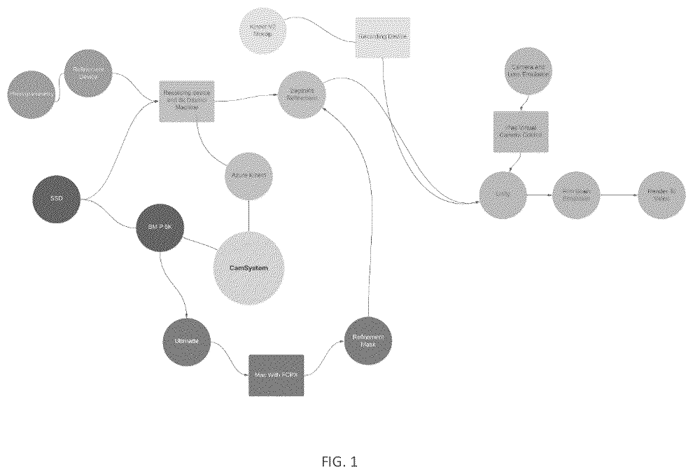

Cinematic cameras and lenses are emulated within Unity, controlled via an iPad, to replicate a real-world filming experience. This innovative approach allows for dynamic camera operation within the virtual environment. Finally, film grain emulation is applied during the rendering process to impart a traditional cinematic texture to the video. FIG. 1 depicts a flowchart of the process.

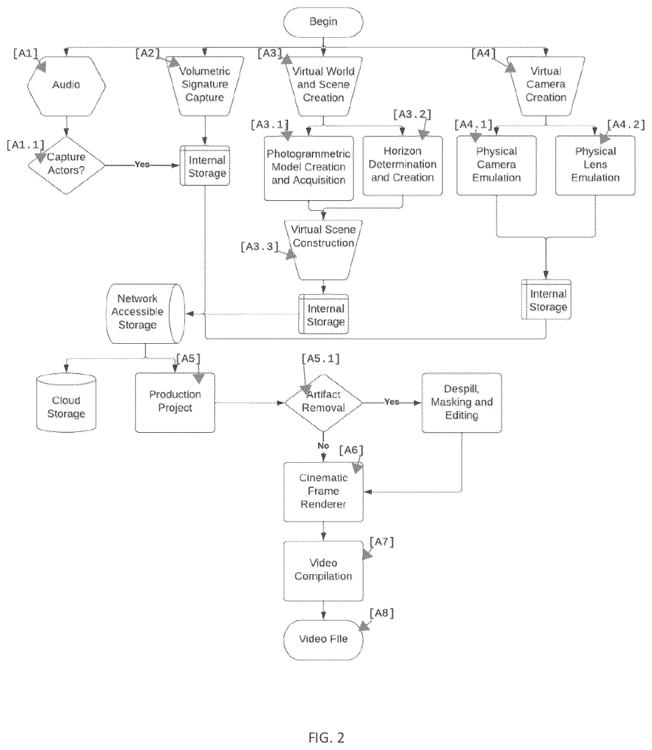

In one embodiment, the first stage of production involves identifying and addressing the needs for the performance capture, virtual world creation, virtual camera creation, and audio. For performance capture, outfits, make-up, and props may be required to enhance the performance. Similarly, for virtual world creation, 3D models, effects, and other assets must be acquired or created. It is also important to determine what cameras, lenses, and types of shots should be created to achieve the desired visual effects. FIG. 2 provides a flowchart of the method.

Referring to FIG. 2, it is important to note that the performer's audio [A1] may also be recorded during the volumetric signature capture. This ensures that the audio is of the highest quality and is well-suited for the video. Virtual world building can begin before the volumetric signature capture process, but it is crucial that the captured volumetric signature is ultimately played back within the completed virtual world to maintain the high level of quality throughout the production.

Audio needs are determined before capturing volumetric signatures. If there is a need to capture the performer's audio it is done simultaneously, cleaned up in editing, and synced in post-production in the timeline to the performance.

If it is necessary to capture the performer's audio, it should be done externally [A1.1] on high-quality recording devices to ensure optimal sound quality. Cameras with built-in microphones may not produce the desired level of audio quality and are therefore not recommended for capturing audio during the performance.

The volumetric signature capture process [A2] involves creating a dedicated space in front of the camera and computer running specialized capture software. The capture space should be at least 9×9 ft in size [FIG. 1], and the operator should be stationed outside of it to monitor the capture process [FIG. 2]. To ensure the highest quality capture, the performer should be lit with flat lighting and the camera and software settings adjusted accordingly.

It is important to choose a solid background color for the capture space that is not white or green to avoid introducing artifacts and making the separation of the performer from the scene more difficult. The performer should also avoid wearing colors that match the background, as well as any highly reflective surfaces or lengthy jewelry that could interfere with the capture.

Once the volumetric captures are complete, they are stored locally on the capture device before being backed up once to a network accessible storage and again in the cloud. It is important to identify and address any captures that include artifacts before proceeding with production, as post-production may need to remove or hide them [A5.1].

Virtual setting construction [A3] involves the use of a high-definition render pipeline within a real-time graphical application to create topographically accurate real-world locations. This is achieved by utilizing photogrammetrically scanned 3D models combined with high-quality physically-based rendering materials, including realistic textures and physically accurate shaders [A3.1]. The construction of the virtual settings also incorporates region-specific flora and fauna 3D models, wind simulations, and accurate fluid and wave-crest simulations where water is present.

To achieve a photorealistic virtual setting and horizon [A3.2], it is essential to have location-accurate ground textures, a physically accurate sky, and precise sun, moon, and star locations, based on date, time, latitude, and longitude. Realistic ray-traced lighting and cinema-quality special effects, such as smoke or fire, further enhance the overall virtual setting's realism.

The 3D assets used in the virtual setting must adhere to strict guidelines. These guidelines dictate that the models must be highly detailed, flatly lit, and delivered in .fbx, .dae, .obj, .3ds, or .dxf formats. The levels of detail are determined on a per-model basis and generated accordingly.

After constructing the scene using all the necessary models, an optimization pass is done. This pass involves removing any unnecessary, unused, or unseen aspects of the scene while applying the determined model levels-of-detail. This optimization pass ensures that the virtual setting is as efficient and effective as possible while maintaining its photorealism.

Each aspect of the scene is specific to each project and tailored to the video production's needs. The project is stored locally, backed up to network accessible storage, and backed up again in the cloud, ensuring that the project remains safe and accessible at all times.

Virtual scene construction [A3.3] is a highly technical process that requires a significant amount of attention to detail. It involves using advanced technology to create photorealistic virtual environments that accurately portray real-world locations. By combining topographical accuracy, photogrammetrically scanned 3D models, high-quality materials, realistic lighting, and special effects, the result is a virtual setting that is both efficient and visually stunning.

Virtual cameras and lenses are created to emulate their real-life counterparts to provide consistency between shots and a cinematic quality aesthetic in-line with mainstream cinematic cameras [A4]. The virtual cameras [A4.1] and lenses [A4.2] are initially created and stored locally but ultimately used in the final project, stored in a network accessible system, and backed up to the cloud.

At this stage, a production project [A5] is created that imports everything created so far, including volumetric signature captures, audio recordings, virtual cameras with lenses, and all assets necessary for the 3D virtual setting. The volumetric signature captures are placed in the virtual setting alongside the placement of any virtual cameras to achieve the intended shot. A virtual timeline is created to control virtual camera movement and shot duration. Any lighting or scaling issues between performers, the virtual setting, and special effects are identified and addressed before proceeding.

Volumetric signature captures should be placed where necessary in the virtual setting alongside the placement of any virtual cameras to achieve the intended shot. A virtual timeline is created to control virtual cameras, special effects, volumetric playback, and more if necessary. Volumetric captures are edited to match the required playback to the timing of the virtual camera shots. Once a subject is finalized in the scene other camera adjustments and post-processing effects can be used to enhance visual fidelity. This includes depth of focus, cinematic anti-aliasing, color grading, bloom, contrast, additional lens distortion, chromatic aberration, vignette, white balance, ambient occlusion, horizon-based anti-aliasing, fog, motion blur and more. Once the cameras are timed to the performer's volumetric playback within the setting, rendering begins at a specified bitrate, resolution and framerate, frame-by-frame, injecting ray tracing and emulated film-grain to assure proper lighting for and recording from the cameras [A6].

Finally, the video is compiled by rendering the series of generated images into a video format [A7]. If necessary, the performer's audio, which is captured externally on high-quality recording devices, is cleaned up in editing and synced in post-production with the performance. This process is designed to improve fidelity over prior methods by using a unique combination of manufacturing techniques.

The rendering process is an essential step in creating the final cinematic video. Rendering involves taking the virtual camera movements and volumetric signature captures and producing individual frames that can be put together into a video sequence. The rendering process can be time-consuming and requires powerful hardware to complete efficiently. The frames are usually rendered in high resolution to ensure high-quality video output.

Once the frames are rendered, they are typically passed through a post-processing stage where visual effects are added and color grading is applied to the footage to give it a cinematic look. Audio is also edited and mixed during this stage to ensure a high-quality sound. The final video is then output in various formats, depending on the intended use [A8].

To achieve the highest possible quality in the final product, it is essential to pay close attention to every stage of the process. The volumetric signature capture must be done carefully to ensure that the performer's signature is captured accurately. The virtual setting construction must be done meticulously to create a realistic environment that complements the performance. The virtual cameras and lenses must be created to emulate their real-life counterparts as closely as possible to provide consistency between shots and a cinematic quality aesthetic. Finally, the video must be compiled and edited carefully to ensure that the audio and visuals are synced correctly, and any necessary cleanup is done to improve fidelity.

One of the most significant advantages of this process is the ability to create realistic environments and special effects that would be difficult or impossible to achieve in real life. For example, virtual settings can be created that are too dangerous or impractical to construct in real life, such as a dangerous stunt involving fire or explosions. Additionally, virtual cameras and lenses can be used to achieve shots that would be difficult or impossible to capture with real cameras and lenses, such as shots from impossible angles or perspectives.

The process of using virtual video composition techniques to produce high-quality cinematic video is a complex and time-consuming process. However, it offers several advantages over traditional video production techniques. One of the main advantages is the ability to work with virtual sets, which can be modified and reused in various productions, saving time and money in the long run.

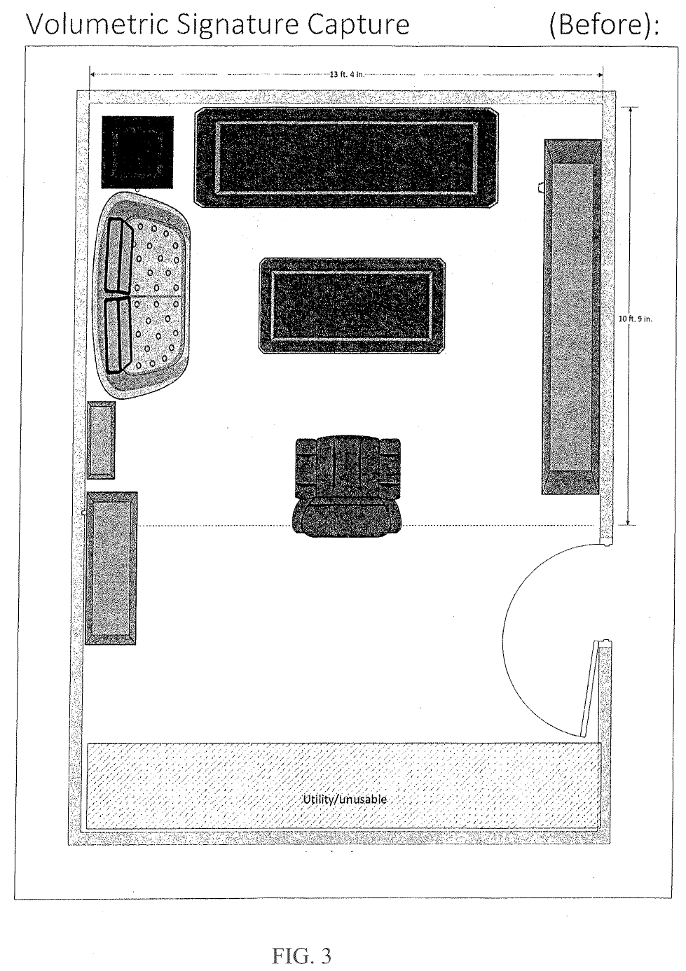

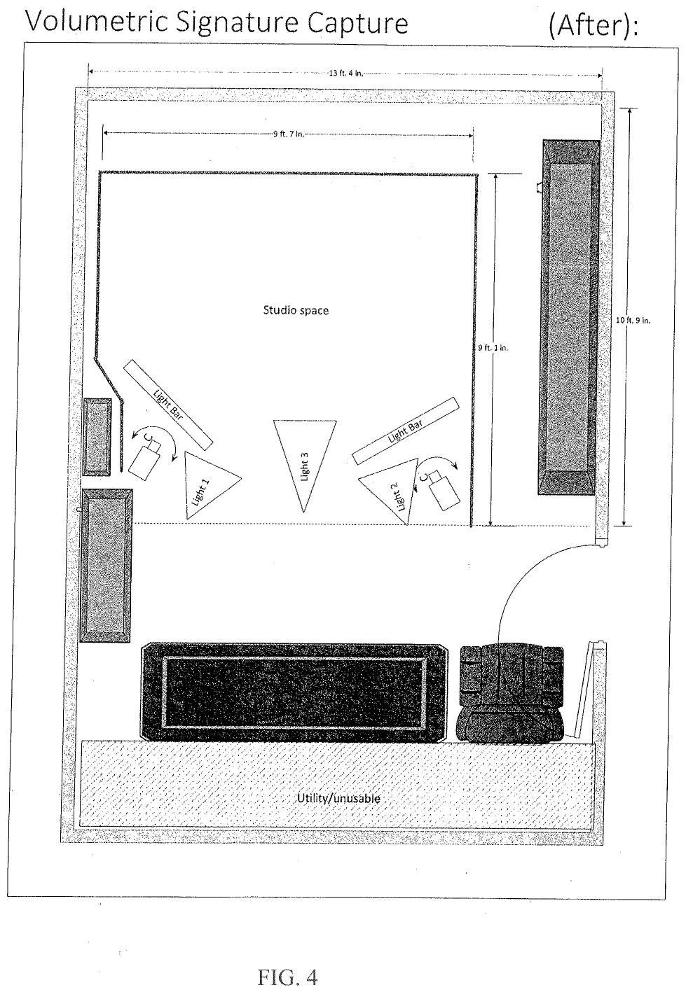

Another advantage is the ability to capture a performer's volumetric signature, which allows them to be placed in any virtual environment and filmed from any angle, providing endless possibilities for creative shots. This is shown before and after in FIG. 3 and FIG. 4. Additionally, the use of virtual cameras and lenses provides filmmakers with greater control over the look and feel of their shots, enabling them to create a cinematic quality aesthetic that is on par with mainstream cinema.

As used in this disclosure the word “comprises” or “comprising” is intended as an open-ended transition meaning the inclusion of the named elements, but not necessarily excluding other unnamed elements. The phrase “consists essentially of’ or “consisting essentially of’ is intended to mean the exclusion of other elements of any essential significance to the composition. The phrase “consisting of’ or “consists of’ is intended as a transition meaning the exclusion of all but the recited elements with the exception of only minor traces of impurities.

It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise that as specifically described without actually departing from the spirit and scope of the present invention as defined by the appended claims.

What is claimed is:

1. A method of virtual video composition comprising:
creating a virtual setting;
creating a virtual camera;
capturing a volumetric video signature;
placing the captured volumetric video signature and the virtual camera in the virtual setting; and
rendering a cinematic video based on the placed captured volumetric video signature and the virtual camera in the virtual setting.

2. A method of virtual video composition comprising:
providing a synchronized multi-camera capture system setup for detailed refinement of a volumetric video signature with intricate photogrammetric modeling complemented by precise bone-mapping;
processing in real time for the removal of visual artifacts;
synchronizing motion capture data with volumetric video;
applying cinematic camera emulation within an interactive virtual setting; and
rendering a cinematic video infused with film grain emulation to thereby achieve an authentic cinematic quality.
